(19) United States
(12) Patent Application Publication
(10) Pub. No.: US 2006/0279626 A1
(43) Pub. Date: Dec. 14, 2006

(54) Optics lens structure of LED printer head

(76) Inventors: Shun Lih Tu, Hsinchu (TW); Huai Ku Chung, Hsinchu (TW); Chih Hung Chuang, Hsinchu (TW); Cheng Wei Yang, Hsinchu (TW); Chieh Chen Hung, Hsinchu (TW); Hung Tung Wang, Hsinchu (TW)

Correspondence Address: LIN & ASSOCIATES INTELLECTUAL PROPERTY, P.O. BOX 2339, SARATOGA, CA, 95070-0339, US

(21) Appl. No.: 11/150,047

(22) Filed: Jun. 10, 2005

(51) Int. Cl. B41J 2/45

(52) U.S. Cl. 347/238

(57) ABSTRACT

An optics lens structure of LED printer head has a light array mould includes a plurality of LED array and driving chip array mounted at a printed circuit board formed at least two orientation points; and a stationary barrier comprising a housing and fastening parts installed at bottom of the housing which is imbedded an optics rod lens array on the top and has at least two orientation points; wherein the orientation points of the printed circuit board are according to the orientation points of the housing for assembling the light array mould and the stationary barrier.

### BACKGROUND OF THE INVENTION

1. Field of the Invention

The present invention relates to an optics lens structure of light-emitting diode (LED) printer head, and in particular to an assembling structure for the optics lens structure of LED printer head.

2. The Related Art

As shown in FIG. 1, an optics lens structure of LED printer head about prior arts has LED arrays 10 and a driving chip array 11 which are assembled by a specific apparatus having a high accurate mechanism. Aurum pads of the driving chip array 11 are connected electrically to the LED arrays 10 by wires 13 respectively. A printed circuit board 12 of the driving chip array 11 which is carried the LED arrays 10 is installed at bottom of a rectangular housing (not showed). The rectangular housing is imbedded an optics rod lens array on the top, and an assembling of these parts usually needs to light the LED arrays 10 for optics measurement. Modify relative position of the rod lens array and the LED arrays 10, light emitted from the LED arrays 10 is focus at the rod lens array. Finally, combine the rod lens array and the rectangular housing, and it completes an optics lens structure of LED printer head.

But the traditional way has the following several shortcomings in the course of produce:

(1) Because it puts LED one by one to construct the LED array, perhaps it make a plurality of the LED align along a line but appear nonlinear arrangement (not shows); and the difference of the position that LED installed is influenced the accuracy of focus on the rod lens array so that the quality printed later is not good.

(2) When the rod lens array is imbedded into the housing, an assembling of these parts usually needs to light the LED arrays for optics measurement until achieving the accuracy. This is time-consuming and heavy and complicated, and is unable to promote the production efficiency.

Because of the drawbacks of the prior arts, the present invention provides an optics lens structure of LED printer head to overcome these drawbacks.

### SUMMARY OF THE INVENTION

A primary objective of the present invention is to provide an optics lens structure of LED printer head comprising LED arrays and a rod lens array has a structure, which makes assembling fast, easy, and accurate.

According to the present invention, to realize the above objective, an optics lens structure of LED printer head has a light array mould comprising a plurality of LED array and driving chip array mounted at a printed circuit board formed at least two orientation points; and a stationary barrier comprising a housing and fastening parts installed at bottom of the housing which is imbedded an optics rod lens array on the top and has at least two orientation points; wherein the orientation points of the printed circuit board are according to the orientation points of the housing for assembling the light array mould and the stationary barrier.

Moreover, a horizontal distance between the imaginational central line of the LED arrays and the imaginational central line of the orientation points of the housing is the same as another horizontal distance between the imaginational central line of the LED arrays and the imaginational central line of the orientation points of the printed circuit board.

The present invention will become more obvious from the following description when taken in connection with the accompanying drawings, which show, for purposes of illustration only, a preferred embodiment according to the present invention.

### BRIEF DESCRIPTION OF THE DRAWINGS

FIG. 1 is a plane view of LED arrays and driving chip arrays according to prior arts;

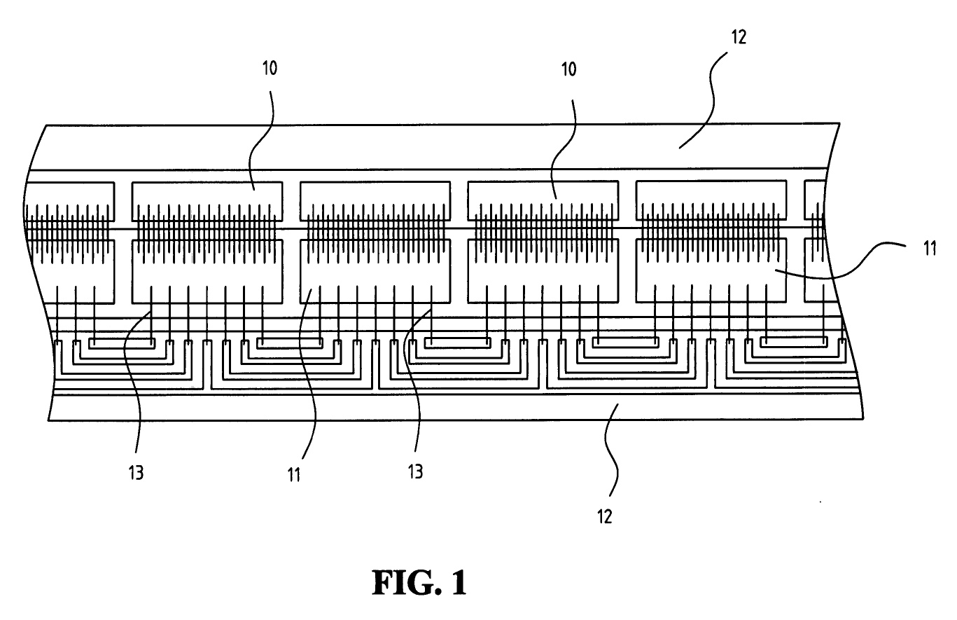

FIG. 2 is an enlarged view of LED arrays constructed nonlinearly according to prior arts;

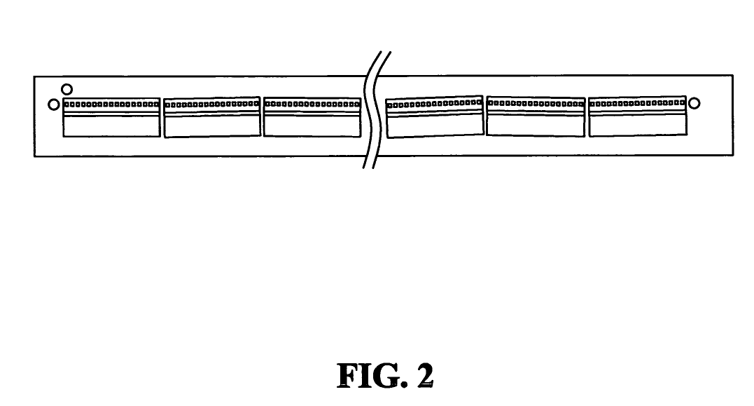

FIG. 3 is a perspective view of an optics lens structure of LED printer head according to the present invention;

FIG. 4 is an enlarged sectional view of the optics lens structure of LED printer head according to the present invention.

### DETAILED DESCRIPTION OF THE PREFERRED EMBODIMENT

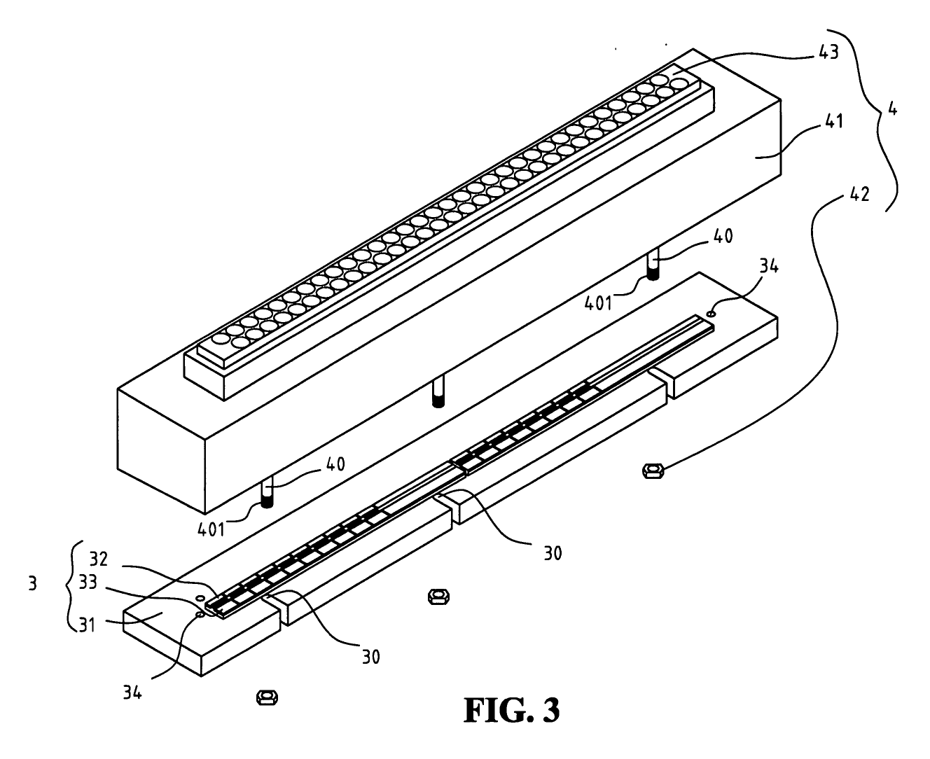

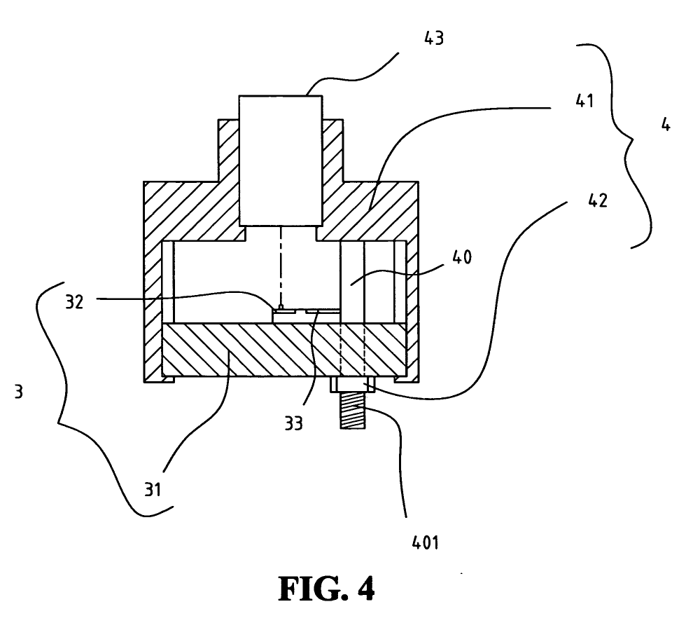

As shown in FIG. 3, it is the exploded schematic view of an optics lens structure of LED printer head according to the invention mainly including a light array mould 3 and a stationary barrier 4. The light array mould 3 which has at least two orientation points 30 installs LED arrays 32 electrically as light source therein. The stationary barrier 4 has a housing 41 and fastening parts 42 installed at bottom of the housing. The housing 41, which is a hollow rectangular structure (as shown in FIG. 4), is imbedded an optics rod lens array 43 on the top and also has at least two orientation points 40 therein. Therefore, when the light array mould 3 is installed at the stationary barrier 4, the orientation points 30 engage with the orientation points 40 to make the vertical positions of the LED arrays 32 be corresponding to the rod lens array 43 respectively and to assemble them fast. Finally, by the fastening part 42, it can make aforesaid components fixed and form the optics lens structure of LED printer head.

The light array mould 3, the light source component installed electrically, has a printed circuit board 31, and a plurality of LED array 32 and a driving chip array 33 mounted thereon, and the LED arrays 32 and the driving chip array 33 are designed as any pattern demanded. For example, U.S. Pat. No. 6,894,315 issued to the present inventor, describes the light array mould. The prior arts have advantage for assembling LED array or longer structure, which makes a thousand of LED elements reach more linear in precision, and are also suitable for the invention. In addition, two optical point 34 labeled on the printed circuit board 31 connect into a straight imagination line which is through central points of the LED arrays 32. The printed circuit board 31 forms two orientation points 30 on one side, and the invention shows an example that the orientation points 30 are grooves or holes.

The stationary barrier 4 which has a housing 41 and fastening parts 42 is used to fix the light array mould 3 therein, so that they form an optics lens structure of LED printer head. The housing 41, which is a hollow rectangular structure, is imbedded an optics rod lens array 43 on the top, and this is different with the prior arts that after insert the optics rod lens array on the top and adjust and mount it. The housing 41 has at least two orientation points 40. In an embodiment, the orientation points 40 are columns, and the orientation points 30 are grooves. A center line of the orientation points 40 is parallel to a center line of the optics rod lens array 43, and a horizontal distance between these two center lines is the same as another horizontal distance between a center line of the orientation points 30 and a center line of the LED arrays 32. Therefore, the grooves, the orientation points 30 of the LED arrays 32, engage with the columns, the orientation points 40, while assembling. It is convenient, fast, and accurate even if the LED arrays 32 overlaps a projection of the optics rod lens array 43. In an embodiment, the fastening parts 42 are nuts, and each column, the orientation point 40, has an outer thread 401 engaged with the fastening parts 42 to fasten the said components.

Synthesizing above state, the invention uses the orientation points on the printed circuit board and the orientation points on the housing to make assembling of the printed circuit and the housing fast. Moreover, the center line of the LED arrays overlays the center line of the optics rod lens array, and it avoid the heavy and complicated traditional assembling method which must light LED array and modify position of the rod lens array to focus. Therefore, it can short the processing time.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. An optics lens structure of LED printer head comprising:
a light array mould comprising a plurality of LED array and driving chip array mounted at a printed circuit board formed at least two orientation points; and
a stationary barrier comprising a housing and fastening parts installed at bottom of the housing which is imbedded an optics rod lens array on the top and has at least two orientation points;
wherein the orientation points of the printed circuit board are according to the orientation points of the housing for assembling the light array mould and the stationary barrier.

2. The optics lens structure of LED printer head as claimed in claim 1, wherein an imaginational central line of the orientation points on the printed circuit board is parallel another imaginational central line of the LED arrays.

3. The optics lens structure of LED printer head as claimed in claim 1, wherein a horizontal distance between the imaginational central line of the LED arrays and the imaginational central line of the orientation points of the housing is the same as another horizontal distance between the imaginational central line of the LED arrays and the imaginational central line of the orientation points of the printed circuit board.

4. The optics lens structure of LED printer head as claimed in claim 1, wherein the orientation points of the printed circuit board are grooves, and the orientation points of the housing are columns which are according to engage the grooves.

5. The optics lens structure of LED printer head as claimed in claim 4, wherein the fastening parts are nuts, and each column, the orientation point of the housing, has an outer thread engaged with the fastening parts to fasten the said components.
